(19) United States
(12) Patent Application Publication
(10) Pub. No.: US 2009/0016836 A1
(43) Pub. Date: Jan. 15, 2009

(54) RETRACTABLE WHEELCHAIR ANCHOR

(76) Inventors: Jean-Marc Girardin, Golden Beach, FL (US); Joe Esteireiro, Weston, FL (US)

Correspondence Address: David I. Roche;BAKER & McKENZIE, 130 E. Randolph Drive, Chicago, IL, 60601, US

(21) Appl. No.: 11/776,223

(22) Filed: Jul. 11, 2007

(51) Int. Cl. A61G 3/08

(52) U.S. Cl. 410/7

(57) ABSTRACT

The inventions described and claimed herein relate to securement devices which are generally used to secure wheelchairs in transit vehicles such as a bus. The preferred embodiment of the inventions is a telescoping arm for a wheelchair anchor which is biased by a spring member or the like in an extended position. The arm is adapted to be at least partially retracted into a housing of the wheelchair anchor, thereby significantly reducing the overall length and size of the wheelchair anchor. The arm of the wheelchair anchor, when unused in the retracted position, protrudes less into an area of the bus which would otherwise be useable by standing passengers. Both the arm and the housing of the wheelchair anchor have securement devices such as restraints attached, such that the wheelchair may be tied down with restraints or the like. The preferred wheelchair anchor also includes a lock and release member which is adapted to lock the arm in the retracted position.

### FIELD OF THE INVENTIONS

The embodiments described and claimed herein relate generally to wheelchair securement devices for transport vehicles. More specifically, a first embodiment described herein relates to an improved retractable wheelchair anchor which includes a spring or the like for biasing the wheelchair anchor in an extended position and includes a pedal or lever for releasing the anchor from a retracted position.

### BACKGROUND OF THE INVENTIONS

The Americans with Disabilities Act (ADA) mandates that all public transit service providers must accommodate persons with disabilities, including those who must use a wheelchair as their seat in the transport vehicle. ADA also mandates that, for the safety of the wheelchair user and near-by passengers, the wheelchair must be secured so that it will not move more than 2″ in any direction during normal vehicle operation. In addition, restraints must be attached to the wheelchair—generally two in front and two in the rear—that are sufficiently strong to keep it secured in the event of a crash event.

There are multiple types of wheelchair securements in use in today's transit vehicles. One example of a wheelchair restraint is a retractable wheelchair anchor, such as the one described in U.S. Pat. No. 6,149,359, which is adapted to be mounted to the floor of a vehicle and serves as a tie-down point for a wheelchair. Prior art retractable wheelchair anchors typically include a plurality of beam assemblies which slidingly engage with one another and which are adapted to collapse or telescope, when not used, to reduce the length of the anchor. As such, the prior art wheelchair anchors, when collapsed or retracted, do not obstruct movement of the wheelchair into or out of position and do not prevent the space in the vehicle from being used for other passengers. The prior art retractable wheelchair anchors include at least two brackets which are spaced from one another when the anchor is in an extended position. These brackets are adapted to be used with restraints for connecting to the wheelchair. Other examples of similar systems are disclosed in U.S. Pat. Nos. 5,888,038; 6,113,325; 6,428,254; 6,575,677; and 6,966,733. With specific reference to FIG. 1 of the 5,888,038 patent, belt retractors are attached to the spaced apart brackets for restraining the wheelchair.

While the prior art retractable wheelchair anchors meet the above described ADA requirements, there are a number of unaddressed problems with the anchors. First, the prior art anchors are believed to be time-consuming and difficult to use. To extend the prior art wheelchair anchors, the vehicle driver must manually release, extend, and lock the anchor in the extended position by hand which undesirably increases dwell time at stops. Some designs even require the use of two hands. Moreover, since the driver must manually release the mechanism, they must constantly bend down to do so. This causes increased potential for back or other work related injuries which is a serious concern for transit operators. Second, although some portions of the prior art anchors retract, at least some of the prior art anchors still include a floor plate which does not retract. The floor plates are adapted to be mounted or bolted to the floor of the vehicle and, as such, can provide an uneven floor surface. Consequently, when the anchor is not in use by a wheelchair passenger, the floor plate could present a tripping hazard for other passengers. Third, the prior art anchors are not designed to hold the retractors at their optimal angle. Instead, the retractors (or restraint straps) are mounted in a vertical direction. Existing restraint straps on the market are designed to be installed ideally where the restraint is horizontally mounted (i.e., the webbing extends from the retractor in the horizontal direction and the width of the webbing is aligned horizontally) and the restraint creates a 45 degree angle towards the chair. The prior art anchors do not accommodate this configuration.

Accordingly, there is a need for a retractable wheelchair anchor which is easy to use and not time-consuming, allows for optimal securement angles, reduces the risk of driver injury, and presents less of a tripping hazard than the prior art anchors.

### SUMMARY OF THE INVENTIONS

The embodiments described and claimed herein solve at least some of the problems of the prior art. Various embodiments of a wheelchair anchor described and claimed herein comprise two or more structures which are configured to telescope between retracted and extended positions. A first embodiment includes two such structures: a housing and an arm, wherein the housing is adapted to be affixed to a floor surface or wall of a vehicle. At least one retractor is mounted to the arm of the wheelchair retractor, although a second retractor could be mounted to the housing.

The first embodiment differs from the prior art in several respects. First, the wheelchair anchor includes not only a biasing member for urging the arm of the anchor in an extended position but also a foot operated locking member for locking the arm in a retracted position. As such, the arm can be extended quickly, simply by stepping on a release pedal which is linked with the locking member. The arm could be locked in the extended position or could be held in the extended position by the biasing member. Thus, extending the arm is a one foot (or hand) operation as compared to the two hand operation of the prior art. Moreover, extending the arm does not require the driver to bend over, thereby reducing the risk of injury. To retract the arm, the arm is simply pushed axially into the housing of the anchor until the locking member engages with the arm. It is believed that such simple and quick extension/retraction will reduce dwell times at stops as compared to the prior art anchors. Second, the first embodiment of the arm can be generally characterized as a cantilever which extends from the housing. As such, the wheelchair anchor does not utilize an elongated track plate. Instead, the first embodiment of the arm utilizes flanges which depend from the housing for mounting the anchor to a floor surface. The flanges are approximately half the length of the track plate of the prior art. Consequently, it is believed that the wheelchair anchor will present less of a tripping hazard as compared to the prior art. Third, the retractors are mounted the first embodiment in their optimal configuration, whereby the axis of the retractor spool is aligned horizontally and the webbing extends from the retractor in the horizontal direction. This configuration presents several advantages as compared to the prior art. For example, the anchor has a lower profile, thereby presenting less of a tripping hazard. Also, aligning the webbing in a horizontal direction also reduces the potential for the webbing to twist inside the retractor (if it's a retractor) causing the restraint to not function properly.

### BRIEF DESCRIPTION OF THE DRAWINGS

These and other features, aspects, objects, and advantages of the inventions described and claimed herein will become better understood upon consideration of the following detailed description, appended claims, and accompanying drawings where:

FIG. 1 is a perspective view of the preferred embodiment of the present inventions in an extended position;

FIG. 2 is a perspective view of the preferred embodiment of the present inventions in a retracted position;

FIG. 3 is an exploded view of the preferred embodiment of the present inventions, depicting the major components;

FIG. 4 is a cross-sectional view of the preferred embodiment of the present inventions with a release lever or pedal shown in a locked position; and,

FIG. 5 is a cross-sectional view of the preferred embodiment of the present inventions with the release lever shown in a release position.

It should be understood that the drawings are not necessarily to scale and that the embodiments are sometimes illustrated by graphic symbols, phantom lines, diagrammatic representations and fragmentary views. In certain instances, details which are not necessary for an understanding of the inventions described and claimed herein or which render other details difficult to perceive may have been omitted. It should be understood, of course, that the inventions described herein are not necessarily limited to the particular embodiments illustrated herein.

Like reference numerals will be used to refer to like or similar parts from Figure to Figure in the following description of the drawings.

### DETAILED DESCRIPTION OF THE DRAWINGS

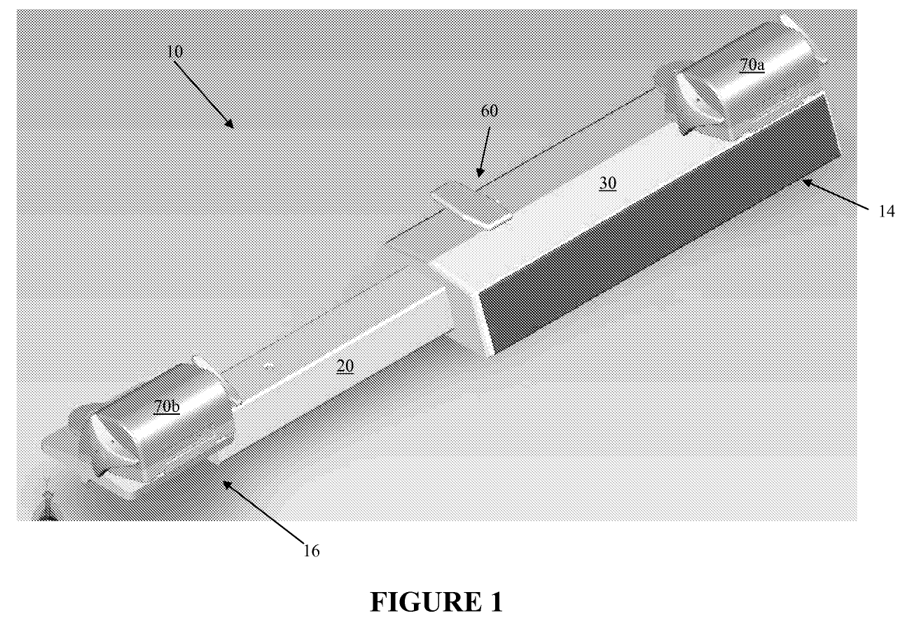

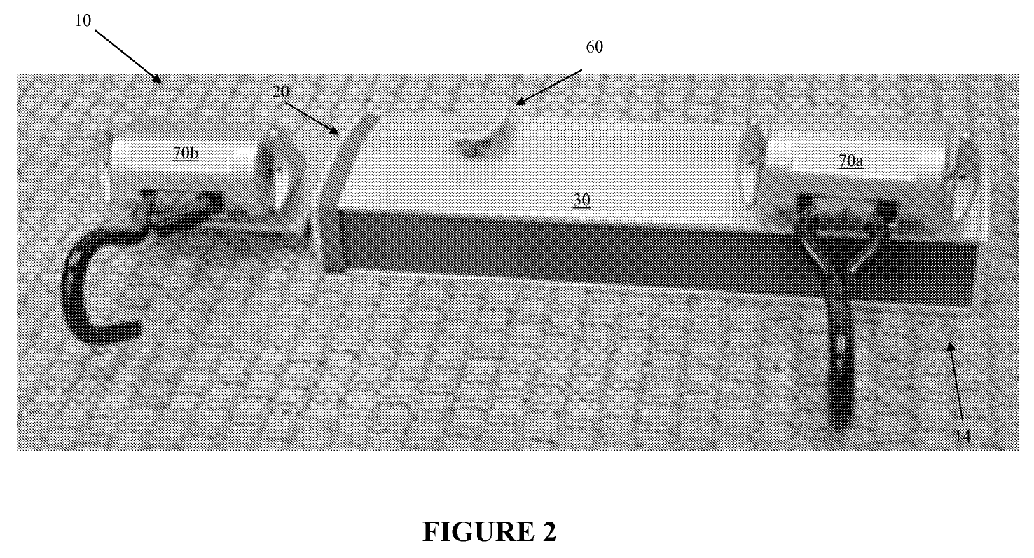

FIGS. 1 and 2 depict perspective views of a first embodiment of a retractable wheelchair anchor 10 which adapted for use in a vehicle as a wheelchair tie-down. The anchor 10 is adapted to be mounted to the floor 6 of the vehicle, although the mounting location is a matter of design choice; i.e., it is contemplated that the anchor could be mounted to other surfaces of the vehicle. The anchor 10 may be mounted to the floor by any appropriate fastening means known in the art, such as bolts. The anchor has two main structural components: the housing 30 and the arm 20. The arm 20 is generally adapted to retract inside of the housing 30 when the anchor 10 is not being used to restrain a wheelchair, in order to increase the available floor space for non-wheelchair passengers. As such, the anchor 10 is preferably mounted such that the longitudinal axis of the anchor 10 is aligned perpendicular to the longitudinal axis of the vehicle and the housing 30 is aligned nearest to the wall of the vehicle.

In a typical use, a wheelchair is restrained at the front of the wheelchair by restraints 12 which extend from the anchor 10. Although the wheelchair will typically be restrained at the rear of the wheelchair by restraints which extend from a barrier, it is contemplated that the wheelchair may be restrained at the rear of the wheelchair by a second retractable wheelchair anchor 10.

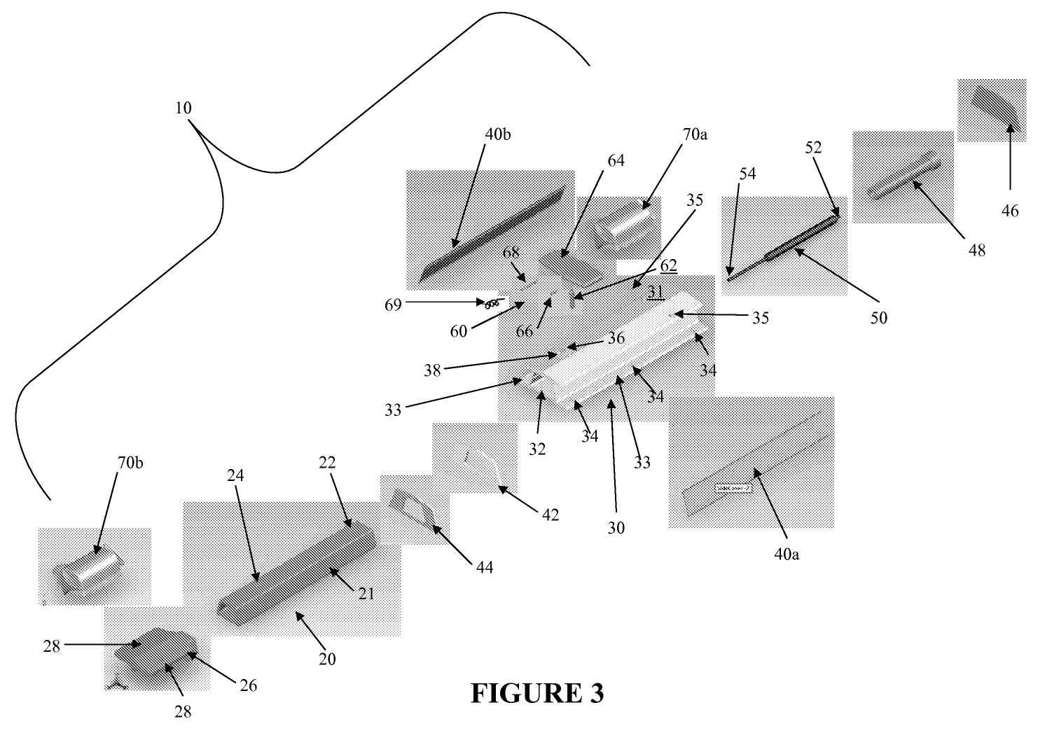

FIGS. 1 and 2 depict the wheelchair anchor 10 in the extended position and the retracted position, respectively. The shown embodiment of the anchor 10 generally comprises a housing 30, a retractable arm 20, two restraint (or belt) retractors 70a and 70b, and a release lever 60. By comparison of FIGS. 1 and 2, it is shown that the arm 20 and housing 30 telescope, wherein the housing 30 overlaps at least a portion of the arm 20. However, it is contemplated that the arm 20 could instead overlap a portion of the housing 30. Either way, the anchor 10 includes a biasing means 50 which is disposed within the housing 30, for urging the arm 20 in the extended position. The biasing means 50 is depicted as a gas spring, however, it is contemplated that the biasing means (or member) could be any other means for biasing that is known in the art, such as a coiled spring, a pneumatic cylinder, or an electric motor. The lever 60 is adapted to manipulate a lock component 62 (note that a pin embodiment of the lock component is shown in FIG. 3) for locking the arm 20 in either or both the extended position and/or the retracted position. The lever 60 is shown as a pedal which can be manipulated by a foot, although it is contemplated that the lever 60 could be manipulated by hand. Alternatively, the lock component 62 could be manipulated electrically by a switch on the wall or at the driver's station. As a result of the configuration described above, manipulation of the release lever 60 when the arm 20 is in the retracted position causes the arm 20 to be released from the retracted position such that the arm 20 automatically extends to the extended position. To retract the arm 20, it is contemplated that the release lever 60 must first be manipulated to unlock the arm 20 and then the arm 20 must be manually urged back into the housing 30 until the lock component 62 engages with the arm 20 when the arm is in the retracted position.

Note that it is contemplated that the biasing means 50 could instead urge the arm towards the retracted position. With such configuration, the manipulation of the release lever 60 when the arm 20 was in the extended position would cause the arm 20 to be released from the extended position such that the arm 20 automatically retracts to the retracted position. To extend the arm 20, the user would have to first manipulate the release lever 60 and then manually extend the arm 20.

Referring now to FIG. 3, an exploded view of the anchor 10 depicts the main components of the anchor 10, including the arm 20, the housing 30, the biasing means 50, the release lever 60, and the restraint retractors 70a and 70b. Note that components which are not necessary for an understanding of the invention, such as various fasteners, are omitted from the figure for simplicity.

The arm 20 is generally comprised of an elongated member 21, which is preferably tubular in structure to provide adequate strength and light weight, and a retractor saddle 26. The retractor saddle 26 includes at least one bore 28 or the like for engagement with a fastener for attaching the restraint retractor 70b to the arm. Although depicted as a separate component, the retractor saddle 26 may be integrated with the elongated member 21 or may be eliminated altogether. Accordingly, the elongated member may include the bores 28 to facilitate attachment of the restraint retractor. Alternatively, the arm 24 may include brackets for mounting of the restraint retractor 70b or for receiving a separate restraint (not shown). The elongated member includes at least one bore 22 or 24 for engagement with the lock component 62, as described in more detail below. As shown, there are two bores 22 and 24 which are aligned along the length of the arm 20 such that the bore 22 engages with the lock component 62 when the arm 20 is in the extended position and the bore 24 engages with the lock component 62 when the arm 20 is in the retracted position.

The housing 30 generally comprises a body 31, a front support plate 42, a rear support plate 46, front cover plate 44, two side cover plates 40a and 40b, and a spring holder or support 48. The body 31 is generally tubular in structure and comprises an opening 32 for receiving the arm, two flanges 33, and at least one bore 35 or the like for engagement with a fastener for attaching the restraint retractor 70a to the housing. Alternatively, the body 31 may include brackets for mounting of the restraint retractor 70a or for receiving a separate restraint (not shown). Each of the two flanges 33 include include a plurality of bores 34 for use with fasteners (not shown) to fasten the anchor 10 to an appropriate surface in a vehicle 2, such as the floor 6 or a side wall. As discussed in more detail below, the tubular structure also includes a flange 38 for engagement with the release lever 60 and a corresponding bore 36 for engagement with the lock component 62. The flange 38 comprises two opposing bores which are adapted to receive a pivot pin 68 about which the lever 64 is adapted to pivot. The spring holder or support 48 is adapted to receive a biasing means or spring 50 and is preferably fixed to the rear support plate which in turn is fixed to the body 31. The front cover plate 44 and the two side cover plates are primarily for aesthetic purposes.

The biasing means 50 is adapted to be disposed between the housing 30 and the arm 20 to bias the arm 20 in either the extended position or the retracted position. The biasing means 50 can be any resilient member known in the arm that is capable of regaining its shape after being compressed or expanded, such as a coil spring or a gas spring. As shown, the biasing means 50 is a gas spring 50 as shown in FIG. 3. The gas spring 50 has two ends 52 and 54, one of which 52 is adapted to exert a force on the housing 30 and the other of which 54 is adapted to exert a force on the arm, thereby urging the arm in either the extended or retracted position. Note that in the first embodiment, the first end 52 is adapted to be disposed in the spring holder 48, while the second end 54 is disposed inside of the elongated member 21.

In another embodiment, it is contemplated that the biasing means is a two-way hydraulic cylinder, whereby the cylinder is powered by the vehicle's pneumatic system. Controls for the arm could be provided near the arm or at the driver's station.

The two restraint retractors 70a and 70b are typical restraint or belt assemblies which house coiled restraints. The first restraint retractor 70a is preferably attached to the housing 30 at a first distal end 14 of the anchor 10, while the second restraint retractor 70b is preferably attached to a second distal end 16 of the anchor 10. However, it is contemplated that the restraint retractors 70a and 70b may be disposed along the length of both the arm and the housing, so long as the restraint retractors 70a and 70b are adequately spaced apart when the arm 20 is in the extended position.

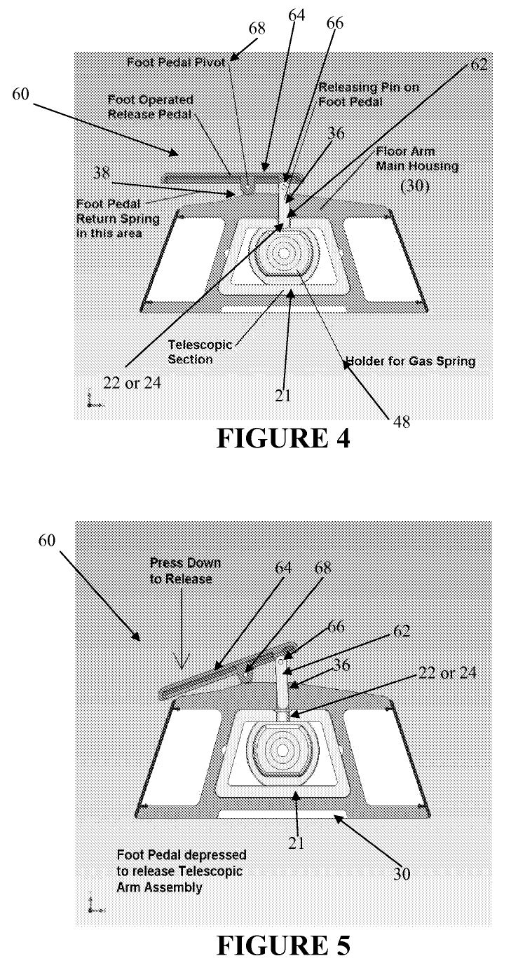

The release lever 60 is generally comprised of a lever or pedal 64, two pivot pins 66 and 68, and a lock component or lock pin 62. As best shown in FIGS. 4 and 5, the pedal 64 is attached to the flange 38 with the pivot pin 68 and the pedal 64 is attached to the lock pin 62 with the pivot pin 66. The lock pin 62 is adapted to be disposed in the bore 36 of the housing 30 and extends a distance sufficient to engage with the bores 22 and 24. As represented in FIG. 6, when the pedal 64 is pivoted about the pivot pin 68, the lock pin 62 is pulled upward out of the bore 22 or 24 to release the arm.

Although the inventions described and claimed herein have been described in considerable detail with reference to certain preferred embodiments, one skilled in the art will appreciate that the inventions described and claimed herein can be practiced by other than the preferred embodiments, which have been presented for purposes of illustration and not of limitation. Therefore, the spirit and scope of the appended claims should not be limited to the description of the preferred embodiments contained herein.

We claim:

1. A wheelchair anchor for securing a wheelchair in a vehicle, the wheelchair anchor comprising:
a housing, an arm, at least one restraint, and an activating member;
the housing being adapted to be mounted to the vehicle;
the arm being movable relative to the housing between a retracted position and an extended position;
the at least one restraint being disposed on the arm near an end portion of the arm, the end portion of the arm being distal to the housing when the arm is in the extended position; and,
the activating member having a first portion and a second portion, the first portion being engaged with the housing and the second portion being engaged with the arm, whereby the activating member is configured to move the arm in at least one direction between the retracted and extended position.

2. The wheelchair anchor of claim 1 wherein the at least one restraint is a bracket which is adapted to be connected to a restraint strap.

3. The wheelchair anchor of claim 1 wherein the at least one restraint is a retractable restraint belt assembly.

4. The wheelchair anchor of claim 1 wherein the activating member is spring.

5. The wheelchair anchor of claim 1 wherein the activating member is a pneumatic cylinder.

6. The wheelchair anchor of claim 1 wherein the activating member is electrically powered.

7. The wheelchair anchor of claim 1 wherein the housing is generally tubular and the arm is disposed at least partially inside of the housing.

8. The wheelchair anchor of claim 7 wherein the arm and the housing telescope.

9. The wheelchair anchor of claim 1 wherein the activating biases the arm in the extended position.

10. The wheelchair anchor of claim 9 wherein the wheelchair anchor further comprises a lock for locking the arm in the retracted position.

11. The wheelchair anchor of claim 10 wherein:
the lock is a pin;
the housing has a first hole and the arm has a second hole; and,
when the first hole of the housing is axially aligned with the second hole of the arm, a first portion of the pin is adapted to be disposed in the first hole and a second portion of the pin is adapted to be disposed in the second hole.

12. The wheelchair anchor of claim 10 wherein the lock is also for locking the arm in the extended position.

13. The wheelchair anchor of claim 10 wherein the wheelchair anchor further comprises a lever which is adapted to manipulate the lock from a locking position to a release position.

14. The wheelchair anchor of claim 13 wherein the lever is a foot pedal which includes a spring for biasing the lock in the locking position.

15. A wheelchair anchor for securing a wheelchair in a vehicle, the wheelchair anchor comprising:
a housing, an arm, at least one restraint retractor, and an activating member;
the housing being adapted to be mounted to the vehicle;
the arm being movable relative to the housing between a retracted position and an extended position;
the at least one restraint retractor being disposed on the arm near an end portion of the arm, the end portion of the arm being distal to the housing when the arm is in the extended position;
the activating member being disposed between the housing and the arm and urging the arm in at least one of the extended position and the retracted position; and,
the restraint retractor having a spool axis which is aligned generally horizontally and a restraint which extends from the retractor in a generally horizontal direction.

16. The wheelchair anchor of claim 15 wherein the activating member is a gas spring.

17. The wheelchair anchor of claim 15 wherein the wheelchair anchor further comprises a lock for locking the arm in the retracted position.

18. A wheelchair anchor for securing a wheelchair in a vehicle, the wheelchair anchor comprising:
a housing, an arm, a first wheelchair restraint, a second wheelchair restraint, an activating member, a lock, and a release;
the housing being adapted to be mounted to the vehicle and being generally tubular;
the arm being at least partially disposed in the housing and being movable relative to the housing between a retracted position and an extended position;
the first wheelchair restraint being disposed on the housing, the second wheelchair restraint being disposed on the arm near an end portion of the arm, the end portion of the arm being distal to the housing when the arm is in the extended position;
the activating member having a first portion and a second portion, the first portion being engaged with the housing and the second portion being engaged with the arm, whereby the activating member is configured to move the arm in at least one direction between the retracted and extended position;
the lock being for locking the arm in the retracted position;
the release being adapted to manipulate the lock from a locking position to a release position;
the restraint retractor having a spool axis which is aligned generally horizontally and a restraint which extends from the retractor in a generally horizontal direction, thereby providing the wheelchair anchor with a low profile.

19. The wheelchair anchor of claim 18 wherein the release is one of a foot pedal or a remote switch.

20. The wheelchair anchor of claim 18 wherein the activating member is one of a gas spring, a coiled spring, an electric motor, and a pneumatic cylinder. _
